(19) United States
(12) Patent Application Publication
(10) Pub. No.: US 2006/0106799 A1
(43) Pub. Date: May 18, 2006

(54) Storing sensitive information

(76) Inventors: Jyrki Maijala, Luhtajoki (FI); Esa Lehto, City Helsinki (FI)

Correspondence Address: SUGHRUE MION, PLLC, 2100 PENNSYLVANIA AVENUE, N.W., SUITE 800, WASHINGTON, DC, 20037, US

(21) Appl. No.: 10/512,403

(22) PCT Filed: Apr. 28, 2003
(86) PCT No.: PCT/FI03/00332

§ 371 Date: Nov. 14, 2005

(30) Foreign Application Priority Data
Apr. 29, 2002 (FI) 20020808

(51) Int. Cl. G06F 17/30

(52) U.S. Cl. 707/8

(57) ABSTRACT

The invention relates to a method, a system, telecommunication servers and a network node for storing sensitive information such that they are easily retrievable when needed for instance using an identity number without extra identifiers, but stored such that they cannot be associated with an individual. The invention is based on the use of an internal identifier and two separate databases such that upon reception of a storage request (700) including data to be stored and the first identifier for identifying the individual with whom the data to be stored is associated, then a second identifier is generated such that its value does not depend on the first identifier; the first identifier and the second identifier are stored in the first database by binding the first identifier to the second identifier; and the data to be stored is stored in the second database together with the second identifier.

### FIELD OF THE INVENTION

The invention relates to storing sensitive information concerning an individual and particularly to storing a patient's prescription and/or other patient data.

### BACKGROUND OF THE INVENTION

Conventionally, prescription data are only stored in an actual paper prescription or possibly in databases of a closed data system used by the physician. Similarly, patient data are maintained stored on paper in what are known as patient records and in addition possibly in a closed data system of a clinic, health centre and/or hospital. Outside organizations have no access to these data. As telecommunication connections have improved, for instance various prescription transfer systems have been developed, most of which are based on the direct transmission of a prescription to the pharmacy delivering the drug, and thus no database of the prescriptions has been accumulated. However, the problem in such solutions is that when writing the prescription, the person has to decide the pharmacy to be used.

As a solution to this problem, a centralized database has been proposed, wherein the prescriptions are stored and from where they can be retrieved in any pharmacy. However, the problem in such a database is that the confidentiality of the data has to be guaranteed, i.e. the fact that outsiders have no way to find out what prescriptions were written for a given individual.

A manner of solving this problem is that the prescription data are stored together with an external identifier relating to the individual, which identifier does, however, not enable the identification of the individual, and access to the data is only by said external identifier. The external identifier may be for instance a biometric identifier, such as a fingerprint, or a code in a personal smart card. However, the use of an external identifier is subject to code readers both at the storing end and the data retrieval end, and even to the individual carrying along the code in a separate card or the like.

Another manner is to secure the data by strong encryption. The problem in strong encryption is that is ages with time and thus becomes unprotected. Prescription and patient data should remain secret for several dozens of years. Encryption is also subject to the use of encryption programs during data storage and the use of a decryption program during data disassembly. These programs are different for different encryption methods. Another drawback in the methods is that an agreement has to be made regarding how the encryption keys are used, stored and changed. In addition, the use of strongly encrypted data for research and other corresponding use is very difficult, and when public key encryption is used, in practice impossible.

### BRIEF DESCRIPTION OF THE INVENTION

The object of the invention is thus to provide a method and an apparatus for implementing the method so as to allow the retrieval of sensitive information by individuals using a generally used individual identifier, such as an identity number, but the sensitive information being stored in such a manner that they cannot be associated with any individual. The object of the invention is achieved by a method, telecommunication servers, network node and system, which are characterized in what is stated in the independent claims. Preferred embodiments of the invention are described in the dependent claims.

The invention is based on separating sensitive information, such as a drug prescription included in a prescription, and the individual's identity data, such as the identity number, from each other at the storage stage by storing the individual's identity data in a first database and the sensitive information in a second database such that the information are bound together by means of a second identifier. The second identifier does not as such include anything that would associate it with a given individual. In this way, sensitive information is retrievable by means of the individual's identifier data, and can be studied at the same time without the individual's identifier data. Herein, a drug prescription preferably includes all medication data in the prescription. In other words, the invention is based on the use of two separate databases by means of an internal identifier.

An advantage of the invention is that sensitive information does not have to be encrypted, since the second database including sensitive information does not include anything that would reveal to anyone studying the information, either permissibly or without authorization, the individual with whom the sensitive information is associated. In addition, the sensitive information is in the use of researchers and authorities without any risk to anybody's privacy and/or without the need to give any secret information to researchers or authorities that would enable the disassembly of the information into a usable form. A further advantage is that during storage or retrieval of information associated with a given individual, the user of the system does not have to have separate reading devices or the like, nor does the individual have to carry along or purchase an identification unit including extra information, such as a smart card. A still further advantage is that since the identifier used in data retrieval is an identifier internal to the system, the end users of the system do not have to attend to the operation of the data security system.

### BRIEF DESCRIPTION OF THE FIGURES

In the following, preferred embodiments of the invention will be described in detail with reference to the accompanying drawings, in which

FIG. 1 shows an exemplary embodiment of a simplified system architecture;

FIG. 2 shows a block diagram of a network node comprising an identifier database according to the exemplary embodiment;

FIG. 3 shows a block diagram of a network node comprising a database including sensitive information according to the exemplary embodiment;

FIG. 4 shows a block diagram of a telecommunication server according to the exemplary embodiment;

FIG. 5 is a flow diagram of the operation of a network node comprising an identifier database according to the exemplary embodiment;

FIG. 6 is a flow diagram illustrating the operation of a network node comprising a database including sensitive information according to the exemplary embodiment; and

FIG. 7 is a flow diagram illustrating the operation of a telecommunication server according to the exemplary embodiment.

### DETAILED DESCRIPTION OF THE INVENTION

In the following, the invention will be described by using as an example the transfer of a prescription via a prescription database from the place where the prescription is written, such as a health centre or a private clinic, to a pharmacy. However, the invention is not restricted to this particular solution, but the present invention is applicable to the storage of any sensitive information, such as patient history, medication history, etc. and its transfer wherever required. Another example of applying the invention is the generation of a common patient history from both the information of a health centre and the information of a private clinic, and the use of the common patient history at either the health centre or the private clinic. The invention is also applicable for instance to storing billing and/or purchase information in Internet commerce.

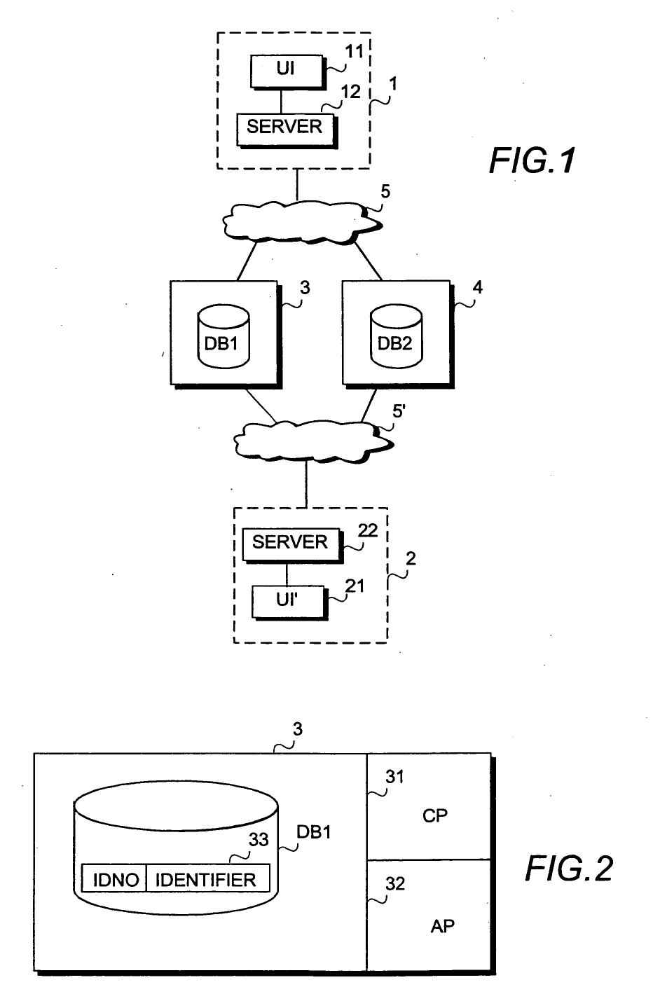

FIG. 1 shows a simplified system architecture showing only the elements required for describing the exemplary embodiment of the invention. The network nodes shown in FIG. 1 are logical units whose implementation may differ from what is described. It is apparent to a person skilled in the art that the system may also comprise other functions and structures that need not be described in detail herein.

The system comprises a health centre system 1, a pharmacy system 2, and two network nodes 3, 4, both comprising databases and two telecommunication networks 5, 5′, via which the network nodes 3, 4 are connected to the health centre system 1 and the pharmacy system 2. In the system, wireless data transfer, data transfer based on a fixed connection, or both can be used.

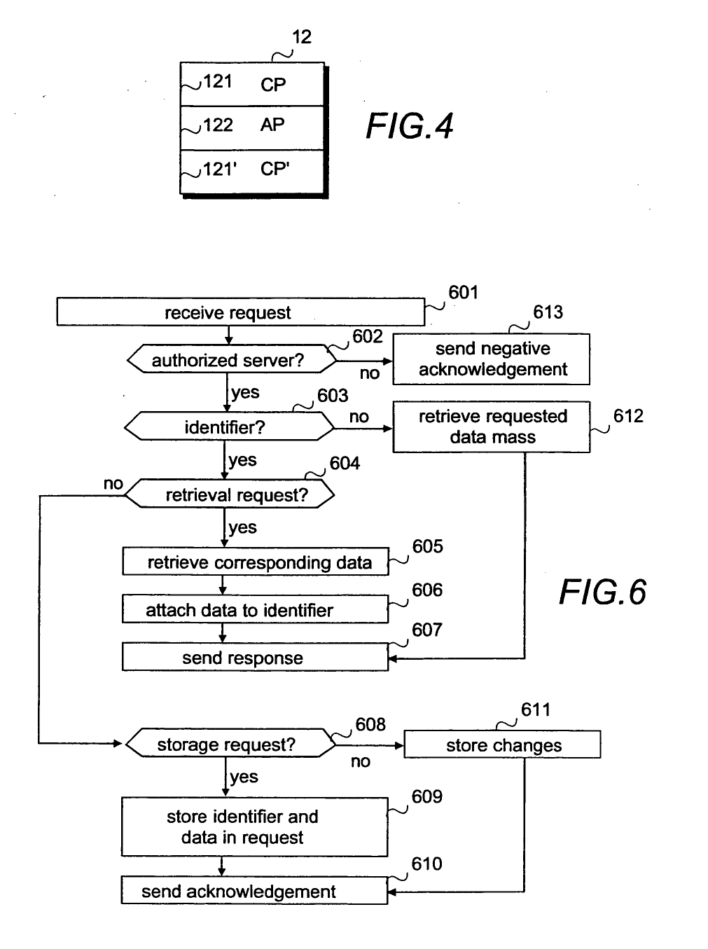

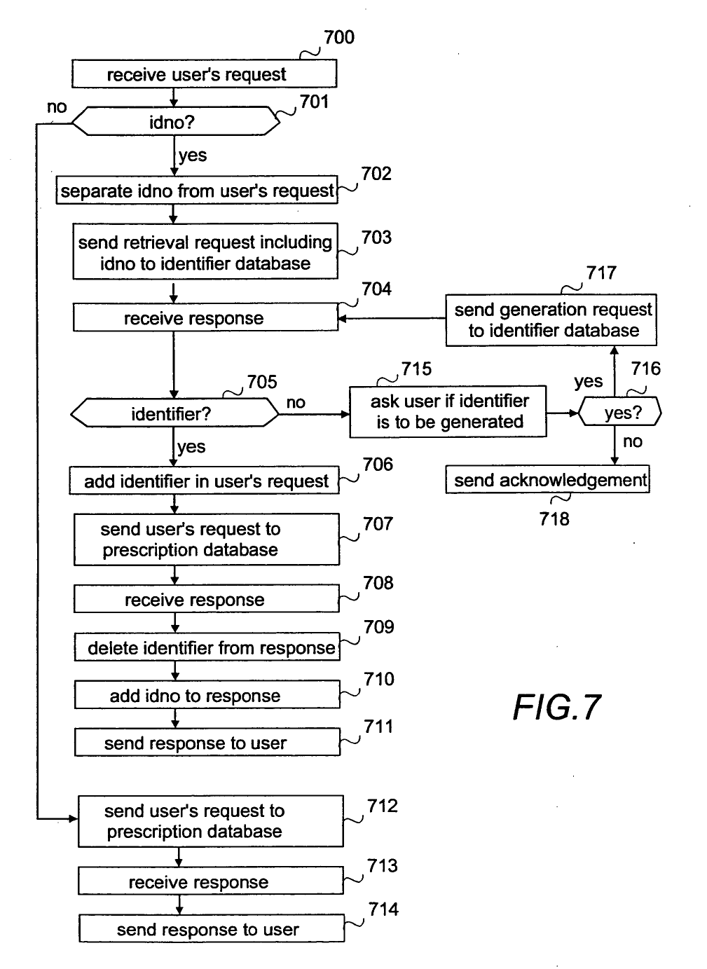

In the exemplary embodiment of FIG. 1, the health centre system 1 comprises at least a prescription storage partition 11 and a telecommunication server 12. The prescription storage partition 11 refers to means and a user interface UI, which enable the generation and transfer of a prescription via the telecommunication server 12 to the database including the prescriptions. The telecommunication server according to the exemplary embodiment is described in detail in association with FIGS. 4 and 7.

In the exemplary embodiment of FIG. 1, the pharmacy system 2 comprises a telecommunication server 22, by means of which the prescription is retrieved from the database including the prescriptions and via which any notes to be made in the prescription can be stored, and a prescription processing partition 21 arranged to display the contents of the prescription via a user interface UI′ to the personnel at the pharmacy, and via which the personnel is able to for instance store information associated with the delivery of the prescription. In the exemplary embodiment, the telecommunication server 22 in the pharmacy system is similar to the telecommunication server 12 in the health centre system. In some other embodiments of the invention, the functions of the telecommunication servers may be different.

It is apparent to a person skilled in the art that both the health centre system 1 and the pharmacy system 2 comprise other subsystems and/or partitions that are not described in detail herein, since they are irrelevant to the actual invention. Examples of these include different identification systems and firewalls for ensuring e.g. that only authorized persons are able to store/read the information. It is also apparent to a person skilled in the art that there may be several health centre and pharmacy systems and/or elements comprised thereby.

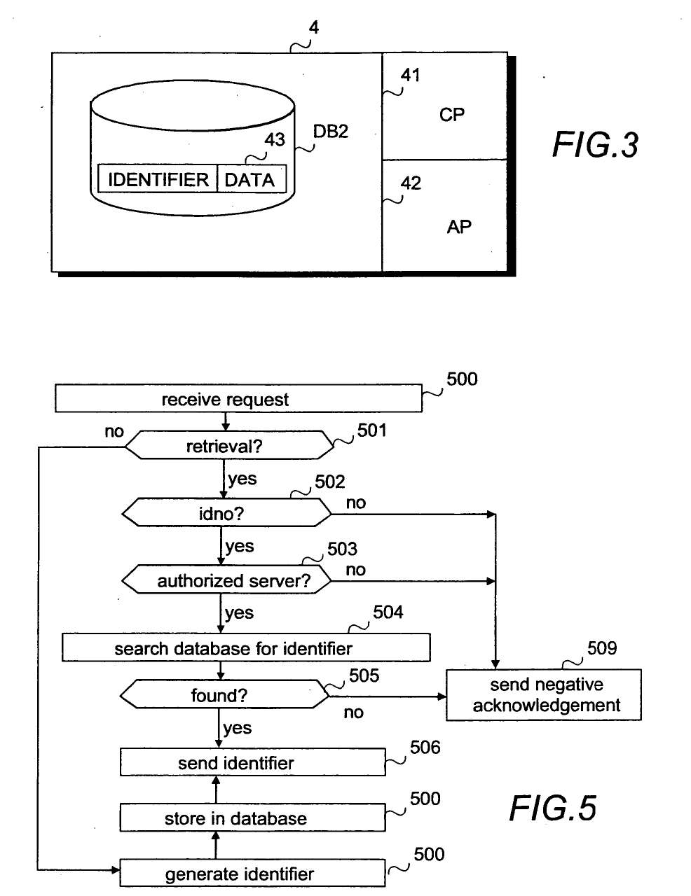

The exemplary embodiment of FIG. 1 comprises two separate network nodes 3, 4, both of which comprise a database DB1, DB2. The databases differ from each other in such a manner that sensitive information is stored in one database, i.e. drug prescriptions in the exemplary embodiment of invention, and data identifying an individual in the other. The structure of the databases will be described in detail in association with FIGS. 2 and 3, and their operation in the exemplary embodiment in association with FIGS. 5 and 6. In some other embodiment of the invention, the databases may be physically located in the same network node, being, however, separate databases. The databases or one of them may comprise several interlinked databases that may be located even physically in different network nodes, which network nodes may be part of a closed or open data network. The interlinked databases may also include different data. For example, an open database may include interlinked databases such that one linked database comprises drug prescription data, the second laboratory data and the third age, length and weight data. For an end user, these interlinked databases behave as one integral database.

Both network nodes including a database are connected to the telecommunication servers 12, 22 via the telecommunication networks 5, 5′. The telecommunication system on which the intermediate networks are based and whether they are based on the same or different systems is irrelevant to the invention. The networks may be for instance Internet networks, telephone networks or mobile networks.

Although the assumption in the exemplary embodiment of the invention is that the telecommunication server is part of the subsystem to which it transfers data from the database or from which it transfers data to the database, it is apparent to a person skilled in the art that the telecommunication server may be arranged as a separate network node or in a node including either database. The fact that the telecommunication server is part of the subsystem brings about the advantage that sensitive information does not have to be sent in a common network together with an identity number. This improves further the data security of an individual.

FIG. 2 illustrates a database including identifiers, a so-called identifier database, i.e. a network node 3 according to the exemplary embodiment, comprising a connection part 31, an application part 32, and a database DB1 including personal data.

The database DB1 including personal data comprises records 33, wherein an identity number IDNO is connected to an identifier IDENTIFIER generated for that particular identity number. The identity number is an identifier used for unambiguously identifying an individual. The generated identifier is preferably unambiguous within the database comprising sensitive data in such a manner that in the database comprising sensitive data, one value of a generated identifier can be associated with only one individual. One individual may have several generated identifiers, but the assumption in the exemplary embodiment is that one individual has only one generated identifier. The database may also comprise, e.g. as a listing (not shown in FIG. 2), information about the telecommunication servers that have access right to the data in the database.

The connection part 31 receives various requests from both the telecommunication server of the pharmacy system and the telecommunication server of the health centre system, and transfers responses to the requests. The requests are typically data retrieval requests inquiring about the generated identifier associated with a given identity number. The connection part 31 may also be arranged to transfer information to the application part 32 about the telecommunication server from which the request was received.

The application part 32 is configured to search the database for the generated identifier corresponding to the identity number and to return it via the connection part 31 to the telecommunication server that inquired about it. The application part 32 may also be configured to check from the database, before retrieval of the generated identifier, if the telecommunication server inquiring about the data is an authorized telecommunication server, i.e. if it is found for instance in the list in database DB1, and if the telecommunication server is not authorized, to send for instance either mere blank data or a negative acknowledgement to the telecommunication server that inquired about the data. The application part 32 may also be configured to add new telecommunication servers to the list of authorized telecommunication servers in the database. In the exemplary embodiment of the invention, the application part 32 is configured to send a negative acknowledgement to the telecommunication server inquiring about a generated identifier if the generated identifier is not found, and, in response to a generation request received from the telecommunication server, to generate the identifier, store it together with the identity number as a record 33 in database DB1, and to send the identifier thus generated via the connection part 31 to the telecommunication server that sent the generation request. The generated identifier may be e.g. a running number. However, the invention does in no way restrict the form and/or contents of the generated identifier. In some other embodiments of the invention, wherein for instance the telecommunication server or some other party attends to the generation of the generated identifier, the application part 32 is configured to for instance send mere blank data or a negative acknowledgement to the telecommunication server that inquired about the generated identifier when the generated identifier was not found. In still another embodiment of the invention, the application part may be configured to generate the generated identifier in response to no generated identifier being found for the identity number, to store it together with the identity number as a record in database DB1, and to send the thus generated identifier via the connection part 31 to the telecommunication server that inquired about it.

Since in the exemplary embodiment only the identifier database is able to associate a given generated identifier with a given individual, sensitive data remain secret in the second database thus guaranteeing the individual's data security.

In another embodiment of the invention, the identifier database may include not only the identity number, but also some less identifying data, such as for instance an address or other demographic data.

In another embodiment of the invention, the identifier database may also include data associated with consent management. In such an embodiment, for instance the consent of a patient is asked to storing his drug prescription(s) in a database and/or to what kind of data can be stored in the database.

In another embodiment of the invention, the identifier database may also comprise subidentifiers that can be used to determine the right of one possessing a subidentifier to process the data in the database including sensitive data. An example of a subidentifier is the identifier of an advertiser. The ads of the advertiser can be sent to the owners of the identifiers to which the advertiser's identifier is attached.

In other embodiments of the invention, the application part 32 is configured to carry out functions associated with the embodiments.

FIG. 3 illustrates a database including sensitive data, i.e. a network node 4 according to the exemplary embodiment, comprising a connection part 41, an application part 42 and a prescription database DB2.

The connection part 41 receives various requests from both the telecommunication server of the pharmacy system and the telecommunication server of the health centre system, and transfers responses or acknowledgements to the requests. The requests are typically data retrieval requests, data storage requests or data edit requests. The connection part 41 may also be arranged to transfer information to the application part 42 about the telecommunication server from which the request was received.

The database DB2 comprising prescriptions includes records 43, wherein all drug prescriptions and any other data associated with the identifier are connected to a generated identifier IDENTIFIER in the exemplary embodiment. In other words, upon storage of data, the record is searched for, which includes the corresponding identifier and the data are stored therein in addition to the data already there. In another embodiment of the invention, the data are stored in smaller records including an identifier and the data stored at that particular time. In this embodiment, when data are retrieved, all records including said identifier are retrieved from the database. At its simplest, the database comprising prescriptions only includes open prescriptions, i.e. prescriptions not yet delivered or those of which only part is delivered. The database comprising prescriptions may also include e.g. medication history, patient history, various background data of the patient, such as age, weight, smoking, etc., information of adverse effects of the medication, results of laboratory tests and/or information about allergies. The database may also include, for instance as a listing (not shown in FIG. 3), information about the telecommunication servers that have access right to the data in the database. The telecommunication servers may also be listed such that some have the right to obtain only data associated with the requested identifier, some have the right only to requests not including an identifier (i.e. mass information), and some telecommunication servers have access right to all data. The database may also comprise subidentifiers usable for instance for determining the rights one possessing a subidentifier has to process the data in the database.

The application part 42 is configured to distinguish the different requests from each other and to act according to them. The application part 42 is thus configured to search the database for the prescriptions corresponding to the generated identifier and to return them via the connection part 41 to the telecommunication server that requested them, to store new prescriptions in association with a generated identifier and to edit the prescriptions in the database. The application part 42 may also be configured to check before retrieval, edit and/or storage of open prescriptions whether the telecommunication server requesting the information is an authorized telecommunication server, i.e. if it is found for instance in database DB2 in a list of those authorized to receive such information, and if the telecommunication server is not authorized, to either send mere blank data or a negative acknowledgement to the telecommunication server that made the request. The application part 42 may also be configured to add new telecommunication servers in the database in the list of authorized telecommunication servers. The application part 42 may also be configured to generate and/or store subidentifiers. In the exemplary embodiment of the invention, the application part 42 is further configured to carry out various database searches. Database searches may be used for instance to find out how many prescriptions (drug prescriptions) were prescribed last month in the entire country or in Helsinki, which was the most frequently prescribed drug combination for the treatment of rheumatism during the last 10 years, how many prescriptions were prescribed for patient A during the last 3 years or “The percentage of prescriptions prescribed last year including drug X. The application part 42 may also be arranged to generate subidentifiers.

FIG. 4 shows a block diagram of a telecommunication server 12 according to the exemplary embodiment of the invention. The telecommunication server may be an individual, separate server or then for example a software module to be linked to the system. The assumption in the exemplary embodiment of the invention is that only one type of telecommunication servers are used in the system, which are added to each subsystem using the databases according to the invention. In other words, in the exemplary embodiment, the same type of telecommunication server is added to all subsystems retrieving data and/or storing data in a database. In some other embodiments of the invention, telecommunication servers may be tailored to execute only the functions required in the subsystem, such as for instance mass data retrievals directly from the database of FIG. 3 without any identifiers.

The assumption in the exemplary embodiment is that the subsystem, as whose part the telecommunication server operates, authenticates the users and the telecommunication instructions in such a way that the telecommunication server is able to trust that only authorized individuals/devices are able to use it. In some other embodiments of the invention, a telecommunication server may include various user and/or device authentication functions and/or devices for data security reasons.

With reference to FIG. 4, the telecommunication server 12 according to the exemplary embodiment comprises two separate connection parts 121, 121′, and an application part 122 between them.

The first connection part 121 is configured to communicate with the subsystem whose part the telecommunication server is. It receives requests from users and forwards them further to the application part, and receives responses to the requests from the application part and transmits them further to the user via a user interface.

The second connection part 121′ is configured to communicate with the identifier database and the database including sensitive data, i.e. the prescription database. The second connection part sends data retrieval or storage requests received from the application part or requests generated based thereon to network nodes comprising databases, and receives responses from them, which it forwards further to the application part.

The application part 122 according to the exemplary embodiment is configured to carry out the functions to be executed in detail in association with FIG. 7. In brief, in response to a request including an identity number, the application part 122 is configured to find out the identifier generated for the identity number, and, depending on the request, either to store, edit or retrieve sensitive information based on the generated identifier. In a corresponding manner, in response to a request not including an identity number, the application part is configured to send the request to the database containing sensitive information. In addition, the application part 122 according to the exemplary embodiment is configured to ask the user if an identifier is to be generated for an identity number when it is not found in the database, and if the user so wishes, to request that the identifier be generated. In another embodiment of the invention, in response to a request including an identity number, the application part may be configured to check the right of the requesting party to make the request, and carry out the functions required by the request only if the requesting party has the right to make the request.

In another embodiment of the invention, the telecommunication server may comprise memory, to which a predetermined number of generated identifiers or a given identifier space is allocated, from which identifiers may be generated. In this embodiment, in response to an empty response or a negative acknowledgement received from the identifier database, the application part 122 is arranged to generate a generated identifier for the identity number, to use it in a request to be sent forward, and send it for storage in the identifier database if the request is a data storage request. The predetermined identifiers or the identifier space brings about the advantage that such an identifier is not generated, which some other telecommunication may have generated for some other identity number.

In another embodiment of the invention, the telecommunication server may comprise a local identifier database. In this embodiment, the telecommunication server is configured to first search its database for a generated identifier and only if it does not find one, request it from the actual identifier database. In this embodiment, the telecommunication server is also preferably configured to synchronize its local identifier database either as often as possible (e.g. every hour) or when required (always after the generation of a new identifier) with the actual identifier database.

FIG. 5 illustrates by a flow diagram the operation of a network node comprising an identifier database according to the exemplary embodiment. The assumption in the exemplary embodiment is that the database also contains a listing of the telecommunication servers that have access to the data in the database.

When the network node receives a request, in step 500 it checks in step 501 if the request was a retrieval request. If so, it checks in step 502 if the request contained an identity number idno. If the request contained an identity number, the network node checks in step 503 if the request was received from a telecommunication server having access to the data in the database. In other words, it checks if the telecommunication server is an authorized server. If so, in step 504, the identifier database is searched for a generated identifier corresponding to the identity number. If the identifier was found in the database (step 505), in step 506 it is sent as a response to the request.

If no retrieval request (step 501) was concerned, in the exemplary embodiment of the invention an identifier generation request is concerned, as a result of which the identifier is generated in step 507 and it is stored in step 508 together with the identity number as a record in the identifier database, and sent in step 506 as a response to the request.

If the request did not include an identity number (step 502) or the server was not authorized (step 504) or no identifier was found, (step 505), a negative acknowledgement is sent in step 509.

FIG. 6 illustrates by a flow diagram the operation of a network node containing a prescription database, i.e. sensitive information, according to the exemplary embodiment. The assumption in the exemplary embodiment is that the database also contains a listing of the telecommunication servers having access to the data in the database such that there is no separate listing of the telecommunication servers that have the right to retrieve data based on the generated identifier and of those that have no such right. The assumption in the exemplary embodiment of the invention is that the requests directed to the data associated with a given individual are separated from mass data requests based on the identifier in the request.

For the sake of clarity, the assumption in the example of FIG. 6 is that the requested data are found. It is apparent to a person skilled in the art that if the requested data are not found, the request is answered for instance by sending a negative acknowledgement, which may contain the reason.

With reference to FIG. 6, when the network node receives a request in step 601, it checks in step 602 if the request was received from a telecommunication server having access to the data in the database. In other words, it checks if the telecommunication server is an authorized server. If so, in step 603, a check is made to see if a request relating to an individual's data or a mass data request is concerned. If the request included an identifier, in step 604 a check is made to see if the request is a data retrieval request. If so, in step 605 the requested data is retrieved, in step 606 the data are attached to the identifier and a response is sent in step 607 to the telecommunication server.

If a retrieval request was not concerned (step 604), in step 608 a check is made to see if a storage request was concerned. If so, in step 609 the data in the request is stored in the database together with the identifier and in step 610 a positive acknowledgement is sent to the telecommunication server. In the exemplary embodiment, each identifier has one record, in which the data are stored in addition to the data already possibly included therein.

If a storage request was not either concerned (step 608), then in the exemplary embodiment a stored data edit request is concerned, whereby, in step 611, the desired changes are stored in the data indicated by the identifier and the request together, and a positive acknowledgement is sent in step 610 to the telecommunication server.

If the request did not include an identifier (step 603), a retrieval request associated with a larger data mass is concerned, of which examples were described above, and in step 612 the requested data mass is retrieved from the database and in step 607 it is sent as a response to the telecommunication server.

If an authorized server was not concerned (step 602), a negative acknowledgement is sent to the telecommunication server in step 613.

FIG. 7 illustrates the operation of a telecommunication server according to the exemplary embodiment. The assumption in the exemplary embodiment is that only an authorized user is able to set up a connection to the telecommunication server. In another embodiment of the invention, the telecommunication server may be configured to carry out various authentication measures. The addresses of the network nodes where the databases to be used are located are configured in the identification database according to the exemplary embodiment. A further assumption in the exemplary embodiment is that the identifiers to be generated are generated in a network node comprising a database.

When the telecommunication server receives a user's request in step 700, it checks in step 701 if the request included an identity number idno. If so, in step 702, the telecommunication server separates the identity number from the user's request and, in step 703, sends a retrieval request including the separated identity number to the network node comprising the identifier database.

If a response was received from the network node comprising the identifier database in step 704, and the response included a generated identifier (step 705), the telecommunication server adds it to the user's request in step 706 and sends, in step 707, the user's request to the network node comprising the prescription database. The user's request to be sent includes the generated identifier, not the identity number.

In step 708, the telecommunication server receives a response from the network node comprising the prescription database, deletes the generated identifier from the received response in step 709, adds the identity number to the response in step 710, and sends the response to the user in step 711. The telecommunication server thus operates irrespectively of the contents of the response. At the same time, the telecommunication server deletes from its memory the identity number it stored temporarily therein. In another preferred embodiment of the invention, the telecommunication may collect a local identifier database and stores therein the identity number together with the associated generated identifier.

If the user's request did not include an identity number (step 701), in step 712 the telecommunication server sends the user's request to the network node comprising the prescription database. Having received a response from it in step 713, in step 714 the telecommunication server sends a response to the user irrespectively of the contents of the response.

If the response received from the identifier database did not include an identifier (step 705), in step 715 the telecommunication server asks the user if he wants an identifier to be generated for the identity number. If the user wants (step 716) that an identifier is generated, in step 717 the telecommunication server sends a generation request to the network node comprising the identifier database, receives a response thereto in step 704, from where the process proceeds as described above.

If the user did not want (step 716) an identifier to be generated, in step 718 the telecommunication server sends an acknowledgement to the user, stating that the information is received. At the same time, the telecommunication server deletes from its memory the identity number temporarily stored therein.

In another preferred embodiment of the invention, the telecommunication server does not store even temporarily the identity number, and in this embodiment the telecommunication server is configured to request an identity number using an identifier generated between steps 709 and 710. In this embodiment, the network node comprising the identifier database is configured to return the identity number to the telecommunication server in response to the reception of the generated identifier.

The steps described in FIGS. 5, 6 and 7 are not in an absolute chronological order and can be executed in an order different from the given one. Other functions, such as user authentication and measures relating to consent management, may also be executed between the steps. For example, the telecommunication server or the network node comprising either database may check if the contacting party has access right to the data, e.g. if the contacting party is a given health centre, a given physician, an authorized advertiser or a pharmacist. Some steps described in the figures, such as checking if the telecommunication server is authorized, may also be omitted. It is also feasible to identify the telecommunication server directly from the request, what kind of a request is concerned, whereby there is no need to check if the request included an identity number or a generated identifier. Similarly, the network node comprising the identifier database is able to identify, e.g. from the structure of the retrieval request, whether the retrieval request is such that if no identifier is found, an identifier can be generated for it, whereby the steps described in FIG. 5 change order, some steps may be omitted and new steps included.

Although the invention is described above on the assumption that only one generated identifier is associated with one identity number, it is apparent to a person skilled in the art that the invention is also applicable to solutions wherein several generated identifiers are associated with an identity number. Based on the above description, the use of databases in these embodiments is apparent to a person skilled in the art.

It should also be noted that the use of the databases is described above using very simplified examples, and it is apparent to a person skilled in the art that very complex database inquiries and data updates can be implemented in the databases according the invention pursuant to the principles of the invention. For example, changing the numbering of the medication can be carried out directly as a mass run in the database containing sensitive information in all the prescriptions including the drug whose numbering changes.

Although the assumption above is that data transfer and the sensitive information to be stored are not encrypted, the invention is not restricted to such a solution. The sensitive information or part thereof can be stored in an encrypted form. Data transfer or part thereof may also be executed in an encrypted form.

Although the invention is described above on the assumption that a patient's personal data are protected, the invention is also applicable to protecting the personal data of the physician writing out the prescription in a corresponding manner by generating generated identifiers for the physicians' identifiers and by storing them either in a special or in the same identifier database.

Although the invention is described above using an identity number as the identifier identifying an individual, it is apparent to a person skilled in the art that other identifiers identifying an individual with a sufficient accuracy can be used alternatively or alongside with the identity number.

The system implementing the functionality of the present invention, its network nodes and system parts comprise not only prior art means but also means for implementing the functions described in detail above. They comprise processors and memory that can be utilized in the functions of the invention. All processing and other means, modifications and additions required to implement the invention can be executed as added or updated software routines, processors and/or with different application circuits (ASIC).

It is obvious to a person skilled in the art that as technology advances, the basic idea of the invention can be implemented in a variety of ways. The invention and its embodiments are thus not limited to the above examples, but may vary within the claims.

1. A method of storing sensitive information in a system comprising two databases, the method comprising:
receiving a storage request including the information to be stored and a first identifier for identifying an individual with whom the information to be stored is associated;
generating a second identifier in such a manner that its value does not depend on the first identifier;
storing the first identifier and the second identifier in the first database in such a manner that the first identifier is bound to the second identifier; and
storing the information to be stored in the second database together with the second identifier.

2. A method as claimed in claim 1, further comprising:
checking, before generating the second identifier, in the first database if a second identifier is generated for the first identifier;
if so, using the second identifier in the first database; and
if not, generating the second identifier.

3. A method as claimed in claim 1 further comprising:
receiving a retrieval request including the first identifier;
retrieving the second identifier corresponding to the first identifier from the first database; and
retrieving the requested information from the second database using the second identifier.

4. A method as claimed in claim 3 further comprising a step of sending, to the request, a response including the requested information and the first identifier.

5. A telecommunication server in a data system comprising at least two databases and a system for generating information to be stored, the telecommunication server comprising
reception means for receiving a request, the request including the information to be stored and a first identifier for identifying an individual with whom the information to be stored is associated;
first processing means for determining a second identifier corresponding to the first identifier in the first database of the data system, the second identifier being generated in such a manner that its value does not depend on the first identifier; and
second processing means for storing the information to be stored together with the second identifier in the second database of the data system.

6. A telecommunication server as claimed in claim 5, wherein
the reception means are also arranged to receive a data retrieval request and to separate it from the storage request; and
the second processing means are also arranged to retrieve the data stored together with the second identifier from the second database of the data system in response to the data retrieval request and to forward the retrieved data without the second identifier to the party making the data retrieval request.

7. A telecommunication server in a data system comprising at least two databases and a system comprising stored data, the telecommunication server comprising
reception means for receiving a request, the request being associated with the stored data and including a first identifier for identifying an individual with whom the stored data is associated;
first processing means for determining a second identifier corresponding to the first identifier in the first database of the data system, the second identifier being generated in such a manner that its value does not depend on the first identifier; and
second processing means for retrieving the stored data together with the second identifier from the second database of the data system.

8. A network node comprising
a database for storing data, and
reception means for receiving a request directed to the database and for separating a first identifier in the request, the first identifier identifying an individual with whom the data to be stored is associated;
generation means for generating a second identifier for the first identifier in such a manner that the value of the second identifier does not depend on the first identifier;
storage means for storing the first identifier and the second identifier in the database in such a manner that the first identifier is bound to the second identifier; and
response means for returning the second identifier in response to the request.

9. A network node as claimed in claim 8, further comprising
processing means for checking if the database comprises a second identifier for the first identifier, and, if not, to trigger the generation means; wherein the generation means are configured to be responsive to the processing means.

10. A data system comprising
at least one telecommunication server
at least a first database comprising records wherein a first identifier identifying an individual is linked to at least one second identifier, which alone does not identify the individual and whose value is generated in such a manner that it does not depend on the first identifier;
at least a second database comprising sensitive information stored in such a manner that each piece of personal information is bound to the corresponding second identifier; wherein
the telecommunication server is arranged to determine a second identifier corresponding to the first identifier in the database in response to a request including the first identifier, to delete the first identifier from the request, to add the second identifier to the request and then to send the request to the second database.
